(19) United States
(12) Patent Application Publication
(10) Pub. No.: US 2013/0238975 A1
(43) Pub. Date: Sep. 12, 2013

(54) OFF-LINE PRESENTATION OF WEB CONTENT

(71) Applicants: Ada Chan, San Jose, CA (US); Alice Liu, Santa Clara, CA (US); Richard J. Williamson, Cupertino, CA (US)

(72) Inventors: Ada Chan, San Jose, CA (US); Alice Liu, Santa Clara, CA (US); Richard J. Williamson, Cupertino, CA (US)

(73) Assignee: Apple Inc., Cupertino, CA (US)

(21) Appl. No.: 13/629,540

(22) Filed: Sep. 27, 2012

Related U.S. Application Data
(60) Provisional application No. 61/609,827, filed on Mar. 12, 2012.

(51) Int. Cl. G06F 17/00

(52) U.S. Cl. 715/234

(57) ABSTRACT

An enhanced reader can provide a user with an off-line browsing experience that is essentially indistinguishable from an on-line browsing experience. In particular, the enhanced reader can allow a user to access essentially all elements (e.g. hypertext elements) in a selected page of web content as well as navigation information such as next/previous page. The user can use the navigation information to view web content in its original form as well as navigate from page to page in those situations where the web content spans more than one page. This off-line navigation experience can be enabled by software that automatically archives web content as part of a background process while a user's device is in an on-line state. In this way, the user's off-line and on-line browsing experiences are substantially indistinguishable from each other.

### CROSS-REFERENCE TO RELATED APPLICATION

This application claims priority under 35 U.S.C. 119(e) to U.S. Provisional Patent Application No. 61/609,827, filed Mar. 12, 2012, and entitled “HIGH FIDELITY OFF-LINE PRESENTATION OF WEB CONTENT”, by Liu et al. which is incorporated herein by reference in its entirety and for all purposes.

### FIELD OF INVENTION

The present invention relates generally to user interface. More particularly, this invention in one embodiment relates to providing an end-user with an off-line browser experience.

### BACKGROUND

With the fast advance of browser technologies and World Wide Web infrastructures, more and more content or applications are accessed via a browser. Most web documents are designed to carry a variety of content elements for multiple purposes. Occasionally, a user interested in a portion of content or an interactive application can be presented with myriads of information of no interest to the user at all. In these situations, a conventional reader application can be used that provides a sanitized version of the content or interactive application to the user. Generally, the sanitized version provided by the conventional reader application includes only the content that the user is interested in. In other words, the sanitized version is devoid of other information such as navigation controls (such as previous or next page), user interface controls of a web document, advertising, marketing, or promotional campaign from a web document and focuses only on the content of immediate interest to the user.

Although the sanitized version of the web content provided offline presents the essential data to the user, the overall look and feel of the web page as envisioned by the web content creator is lost as well as any information, such as navigation information.

Therefore, it is desirable for a user to access a web document in a manner that retains the essential look and feel as well as other information included in an original web document.

### SUMMARY OF THE DESCRIPTION

In one embodiment, an enhanced reader can provide a user with an off-line browser experience that is essentially indistinguishable from an on-line browser experience. In particular, the enhanced reader can allow a user to access essentially all elements (e.g. hypertext elements) in selected page of web content as well as navigation information such as next/previous page. The user can use the navigation information to view web content in its original form as well as navigate from page to page in those situations where the web content spans more than one page. In other words, the user is able to navigate between multiple pages while off-line in essentially the same manner as would be available on-line. In this way, the user's off-line and on-line browsing experiences are indistinguishable from each other.

More specifically, a computer implemented method for presenting a high fidelity version of an article that spans more than one web page in a browser in an offline mode is described. The method is carried out by performing at least the following operations. Providing by the browser a URL associated with at least a first page of an article selected from a reading list, using the URL to identify a memory location of stored web content data in a local memory device, the stored web content data corresponding to the selected at least first page of the article, determining navigation links associated with subsequent pages of the article, the navigation links being mapped to memory locations in the local memory associated with the subsequent pages, retrieving the stored web content of the at least first page from the local memory location, passing the retrieved web content of the at least first page to the browser, presenting the web content of the at least first page in its entirety by the browser, and using the navigation links to retrieve the web content of the subsequent pages of the article for presentation by the browser in their entirety.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating one embodiment of a system, such as in a data processing system or a computer, for presenting web content;

FIG. 2 illustrates a representation of a website that can be saved to a locally stored location for later off-line viewing in a reader mode;

FIGS. 3A and 3B are state diagrams in accordance with the described embodiments;

FIG. 4 is a flowchart detailing a online process for identifying and storing web content in accordance with the described embodiments;

FIG. 5 is a flowchart detailing a offline process for reading archived web content in accordance with the described embodiments;

FIG. 6 is a block diagram of an arrangement of functional modules utilized by an electronic device; and

FIG. 7 is a block diagram of an electronic device suitable for use with the described embodiments.

### DETAILED DESCRIPTION

Methods and apparatuses for presenting a full version of web content in a reader mode are described herein. In particular, a copy of an article on the web that spans more than one page is saved locally. Information that links the locally stored pages in the form of navigational links can be mapped to the location in memory where the corresponding web pages are stored. In this way, a user can view all of pages and associated web content offline in essentially the same manner as would be the case if the user was online

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” is an indication that a particular feature, structure, or characteristic described in connection with the embodiment can be included in at least one embodiment of the invention. The appearances of the phrase “in one embodiment” in various places in the specification do not necessarily all refer to the same embodiment. The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

A copy of an article on the web that spans more than one page can be saved locally and viewed off-line by a browser in an enhanced reader mode. In one embodiment, navigational links to subsequent pages of the article can be mapped to the locally stored copies of those pages. In this way, when the online version of the article is not available, the navigational links can be used to automatically navigate to the locally stored copies of the pages. The enhanced reader mode for an article can be identified from content received (e.g. web content as a hypertext document received at a browser) to allow a user to access essentially all elements (e.g. hypertext elements) in the content, such as texts or other elements (e.g.; an image, a table, etc.) as well as navigation information such as next/previous page provided the user with an off-line experience that is indistinguishable from an online viewing of the same web content. For example, using the enhanced reader, the user is able to view web content in its original form as well as navigate from page to page in those situations where the web content spans more than one page. In other words, the user is able to navigate between multiple pages while off-line in essentially the same manner as would be available on-line affording the user off-line and on-line browsing experiences that are indistinguishable from each other. Accordingly, the enhanced reader mode will generally contain all the information in an offline reader mode that would otherwise be available in an online reader mode.

While online, an enhanced reader application can identify and store hypertext elements such as text, images, tables, navigation information, and so on associated with an article in a local memory. If the article spans more than one page, then information such as navigation links that point to the subsequent pages can be mapped to memory locations in the local memory where the content of those pages are stored. The URL associated with a page of stored hypertext elements can then be mapped to the locations in local memory of the corresponding stored hypertext elements. In an off-line enhanced reader mode, when a user selects an item presented in a reading list, the browser can use the URL corresponding to the selected page to retrieve the selected items associated with the page. The enhanced reader application will use the URL corresponding to the selected page to identify locations in local memory at which appropriate hypertext elements such as text, images, and navigation information are stored using the aforementioned mapping. If the enhanced reader application determines that the selected URL contains next or previous page navigation elements, then the memory locations previously mapped to the navigation links that contain the stored webpage content can be accessed and the web content stored therein presented to the user in a manner indistinguishable from the online experience. In this way, the user can seamlessly navigate between multiple pages of an article while offline in a manner that is indistinguishable from viewing the same article online

In one embodiment, the enhanced reader mode is only active when the user is in communication with a WiFi ((IEEE) 802.x) or similar packet based network. When the enhanced reader mode is available (it is determined that the user's communication device in connected to a WiFi network, for example, the reader can cause activation of the enhanced reader mode with a user selectable option (e.g. via a user interface item). As a result, computing resources for activating the enhanced reader mode can be instantiated. In contrast to conventional reader applications, the enhanced reader application can when off-line view web content across a number of pages in its original form with the intent of the content originator preserved. A user wanting to have every page of an article available with a conventional browser would have to save each page of the article individually, taking a user significantly more time to complete, if that user remembers to do so at all.

In some embodiments, email or other messaging capabilities may be provided to allow a user to send out an article presented in an enhanced reader mode directly. For example, a message may be automatically generated to include an archived hypertext document (e.g. an HTML page or pages formatted according to in a mode consonant with the receiving device). Optionally, the message may include a title based on a title of the article. Essentially all elements from original content for the article including navigation information can be generally included in the message. Multiple pages for the article hyperlinked to the original content may be preloaded to be included in the message along with corresponding URL/memory location mapping information, even before the user actually views the texts in the hyperlinked pages in the reader mode.

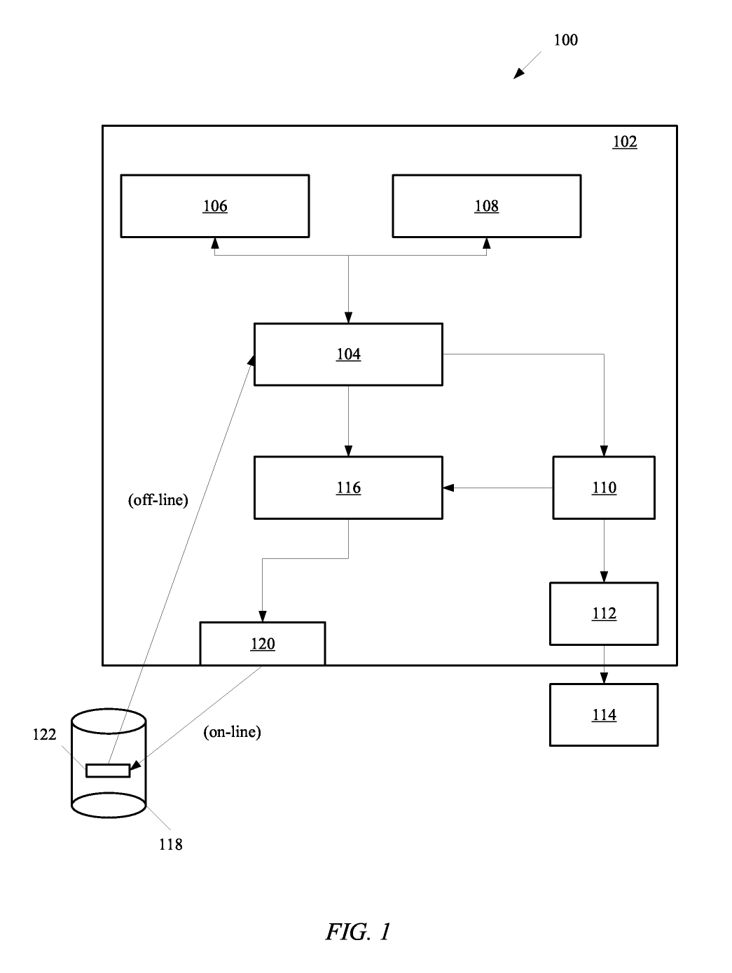

FIG. 1 is a block diagram illustrating one embodiment of a system 100, such as in a data processing system or a computer, for presenting web content in an enhanced reader mode. System 100 can be a computer operating environment including an operating system and/or an application 102, such as a content viewing application with an enhanced reader mode capability to present archived web content in high fidelity by which it is meant that the archived web content is presented offline essentially in its original form. In addition, navigation information is also available to provide the user with the ability to navigate seamlessly between pages in multi-page web content. Application 102 can be built into a browser and capable of detecting availability of web content received and providing an option to present the web content in an off-line mode to a user. Processing module 104 can retrieve a document or web content from a network via a network interface 106 (e.g., from a remote web server) or a file system locally or remotely coupled via file system interface 108. In one embodiment, the content received can be a hypertext based document encoded in languages such as HTML (Hyper Text Markup Language), XML (Extensible Markup Language), or other markup languages, etc. processing module 104 can process (e.g. parse) a document to identify document elements and generate or build a document object model (DOM) tree or DOM structure 110 out of the document elements. A document element can be a hypertext element such as an HTML tag in an HTML document. In one embodiment, DOM tree 110 can represent a topological or structural relationship among the document elements. Each node in DOM tree 110 of a document can correspond to one document element of the document. Document elements can include document content and/or layout specifications, such as size attributes associated with HTML tags in an HTML document, for presenting the document content, e.g. via presentation module 112 to display a user interface rendering a web page on a display screen via user interface module 114. In one embodiment, processing module 104 can include a rendering engine to generate rendering information, such as layout parameters (e.g., sizing data of a rectangular area) for each node in DOM tree 110 for presenting a corresponding document. The rendering engine can make rendering decisions according to configurations including layout specifications in a document, user interface settings for application 102 and/or other system settings, etc. A rendered DOM tree can represent web content such as a web page presented by a browser.

In one embodiment, processor 104 can communicate with URL mapping module 116 arranged to map DOM node information (such as URL corresponding to web page associated with a DOM node) to a location in local memory 118 via memory interface 120. Local memory 118 can be arranged to store the web content associated with a particular web page and related web pages. In one embodiment, URL mapping module 116 can populate a look up table (LUT) 122 or other data structure that, for each page, associates a memory location (ML) or locations in local memory 118 at which web content associated with a particular web page is stored. Accordingly, when a user activates an article from the reading list while off-line, the browser will issue a URL associated with a specific web page which URL mapping module 118 will map to a specific location in local memory 118 where the web content associated with the particular web page is stored. The stored web content can be retrieved and returned to processor 104 and presented to the user in essentially the same manner as if the user was on-line. Accordingly, since the actions of the browser in the off-line enhanced reader mode are essentially the same as in the on-line mode (all off-line mode operations are performed in the background) the user's offline browser experience can mimic the user's on-line browser experience. For example, as in the on-line browser experience, when the user desires to move from a current page to a next or previous page, the user can simply click on a “next page” or “previous page” icon causing the browser to generate the URL associated with navigation information (such as “next page” or “previous page”) that can be mapped to a memory location corresponding to the particular next or previous page. The web content stored in the indicated memory locations can then be retrieved and returned to processor 104 for presentation by presentation module 114.

In one embodiment, copies of an article can be stored locally while the user is online and reading the article. In this way, if for some reason the network becomes unavailable (such as a server goes down), then when a determination is made that the network is unavailable, the enhanced reader mode can automatically take over. In this way, the user can continue the reading of the article including page to page navigation without interruption.

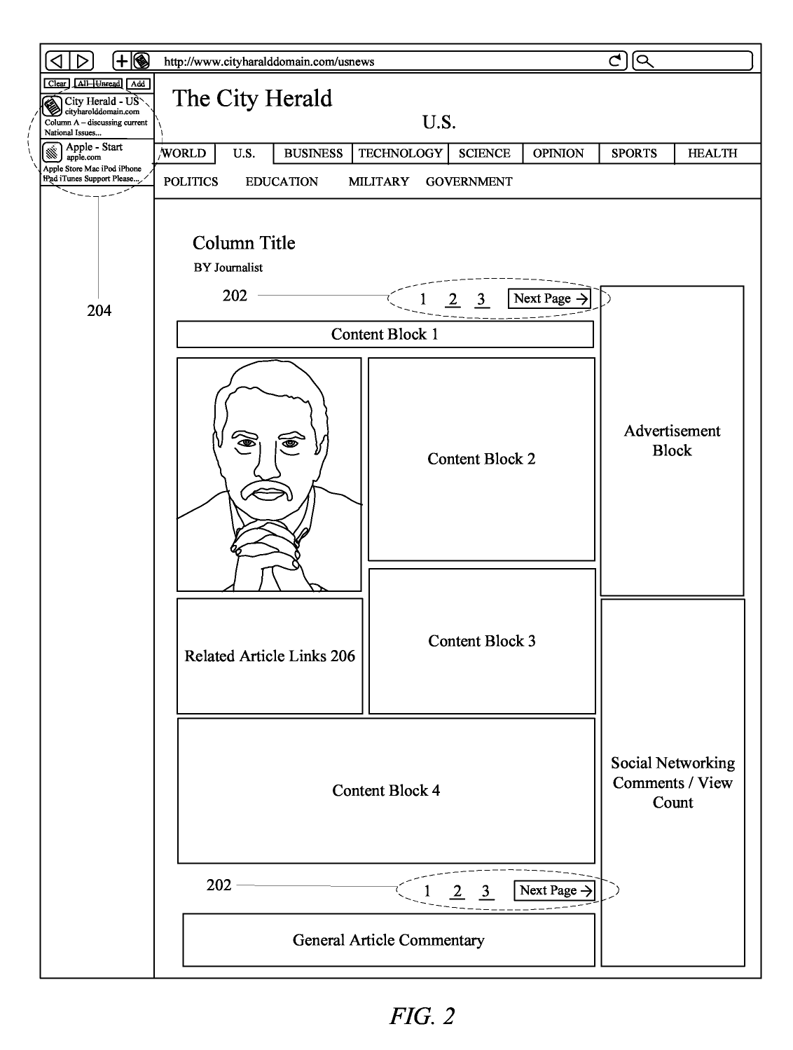

FIG. 2 illustrates a representation of a website that can be saved to a locally stored location for later off-line viewing. Web browsers such as Safari designed by Apple Inc. of Cupertino, Calif., can have a convenient feature which allows a user to archive a web page for later viewing. Web archives capture the look and feel of a webpage as originally designed by the publishers at the moment in time at which the archive is created. Unfortunately, the problem that web archiving software has is that it only saves a single page of an article at a time. A user desiring to archive a multi-page article would have the tedious task of manually clicking through each page of the article. The web archiving feature is indicated in this figure as web archive window 204. Here a user has chosen to archive an article from the City Herald. A browser application could archive this page and make it accessible for off-line viewing in web archive window 204. However, this particular page as shown in page navigation section 202 has three pages. When a user selects this page for archiving the described embodiment can take the page navigation information stored as part of the DOM node information (described more fully under FIG. 1) and perform archiving processes in the background thereby saving page 1 and associated pages 2 and 3. In this way the user can have access to the other pages in the article while the device is in an offline state. In cases where a web archive is created from page 2 of an article, page navigation URLs can still be used to save pages 1 and 3.

One purpose of the described embodiment is to give the user an experience that closely mimics the experience of browsing the internet with a network connection. An archived page can include snapshots of advertising information, social networking commentary, and even general article commentary all viewable in an offline state. In some cases a user browsing through stored items in web archive window 204 might not realize there isn't an active connection to the internet. This is the case because pages 2 and 3 would be accessed by simply clicking the links found in page navigation sections 202. Where the underlying linked content has been archived it is displayed almost as if there were actually an active internet connection. In some implementations of the described embodiment more or less information relating to the archived page can be saved to the internet browsing device. For example, in a default state only content pointed to by identified page navigation URLs would be saved. In an expanded state the amount of archived information could be broadened; in the exemplary website shown in FIG. 2 archived copies of pages linked to from related article links 206 can also be stored. It should be noted that in one embodiment the content saved by the enhanced reader mode is only a single snapshot in time. Therefore, any dynamic or updated content such as user comments, social media remarks or article updates would not be included in the archive; however in other implementations of the archiving tool a user might choose to update articles saved in web archiving window 204 at certain periodic intervals, or alternatively whenever a high speed connection such as WiFi is available.

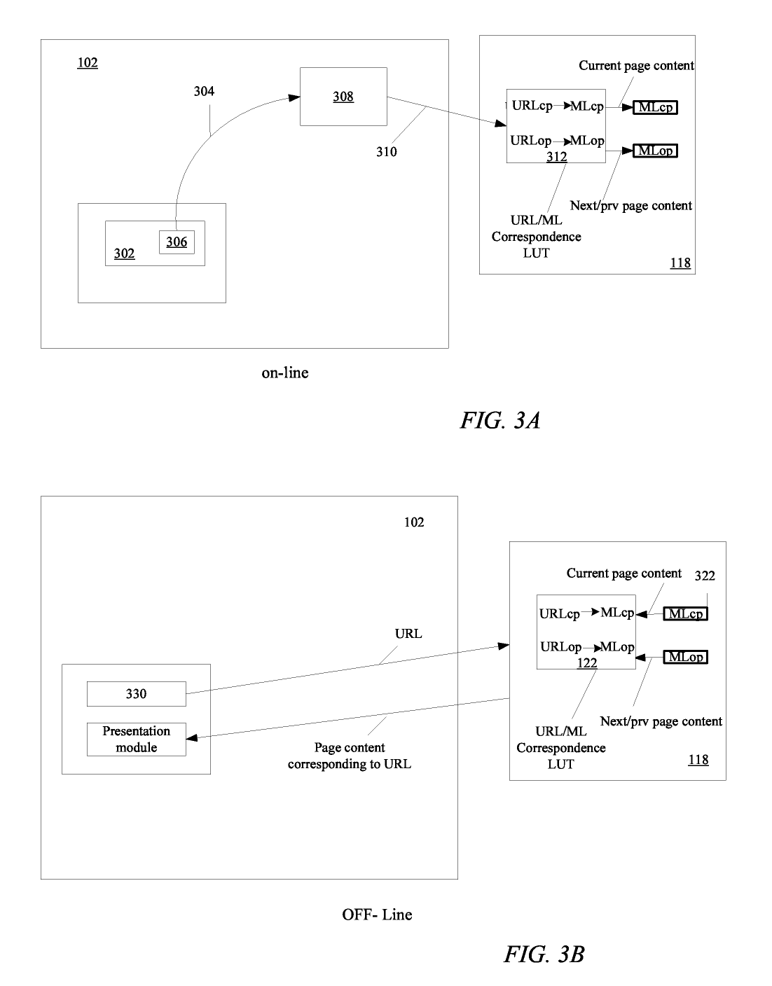

FIGS. 3A and 3B illustrate state diagrams of system 100 in accordance with an online reading list generation and a high fidelity off-line browsing mode, respectively, in accordance with the described embodiments. Turning first to FIG. 3A, system 100 can include browser 302 arranged to generate URL 304 when a user selects item 306. Selection of item 306 can be made by an article selection control allowing at least a currently displayed web page to be designated for later off-line viewing. In one embodiment, URL 304 can be used to identify a particular web page. URL 304 is then passed to DOM tree generator module 308 used to generate a DOM tree associated with URL 304. DOM tree generator module 308 can identify specific hypertext elements associated with the web page corresponding to URL 304. For example, DOM tree generator 308 can parse information associated with the web page associated with URL 304 for links or other type pointers indicating that additional web pages are associated with URL 304. For example, if the web page associated with URL 304 has a link corresponding to a next web page (meaning a subsequent web page) or a previous web page, then the URL for the next web page or the previous web page can be identified and used for subsequent processing. DOM tree generator module 308 can pass information 310 (such as web content/other links) to local memory 118 arranged to store both content data and links associated with URL 304 as data stored as corresponding memory location information at specific memory locations. In the described embodiment, the memory location (ML) information can point to locations in local memory 118 for storing web content associated with URL 304 and information 310. In one embodiment, the URL/ML information is embodiment as look up table (LUT) 312. In one embodiment, next (or previous) web page content is also stored each associated with a URL corresponding to the next (or previous) web page.

Turning now to FIG. 3B showing a state diagram in accordance with an off-line browsing experience. When the user is no longer online but still desires to have a browser experience indistinguishable from an on-line browser experience, in an enhanced reader mode, the user can select an item from reading list 320. In response to the selection of an item from reading list 320, browser 302 can respond by providing URL 304 (in the same manner as described above). In this way, the off-line mode or on-line mode is essentially transparent to browser 302 since browser 302 responds to a selection event in the same way in either case, i.e., providing URL information corresponding to the selected item. However, operations in the background can be substantially different between the on-line mode and the off-line mode. For example, in the off-line mode, URL 304 will be forwarded to LUT 122 in local memory 118 (and not to a network connection as would be the case in the on-line mode) where corresponding memory location 322 is used to access web content stored in local memory 118. The web content retrieved from local memory 118 is then passed from local memory 118 to presentation module 112 for processing. In this way, the user's offline browser experience will indistinguishably mimic the on-line browser experience.

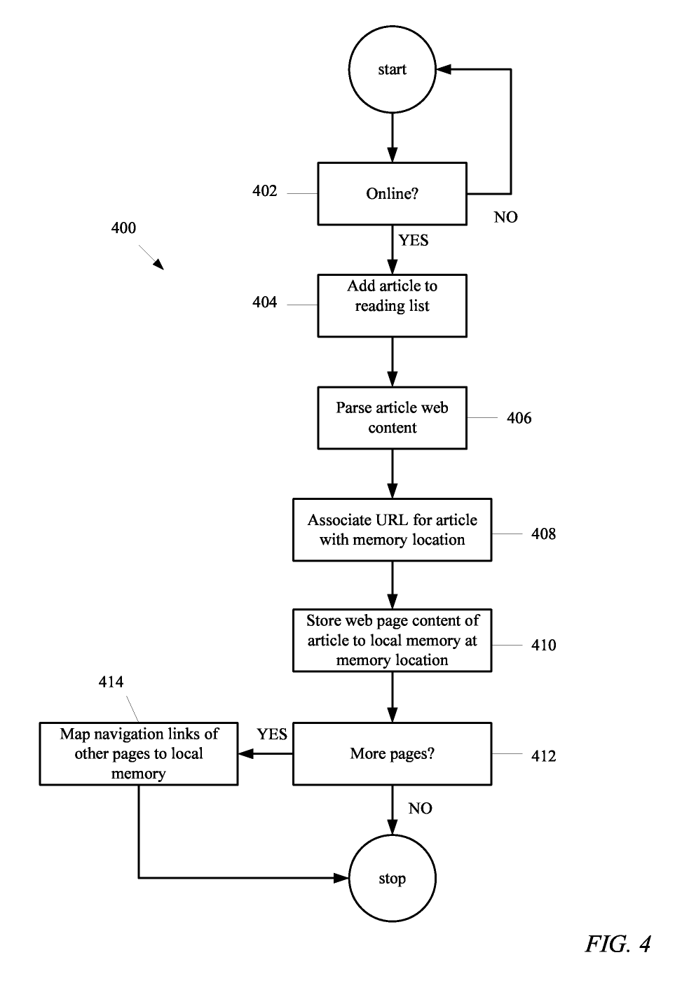

FIG. 4 shows a flowchart detailing an online reading list generating process 400 in accordance with the described embodiments. Process 400 can begin at 402 by a determination if the browser has access to a network (i.e., is online). When the browser is determined to be online, a reading list can be updated at 404. In one embodiment, the reading list is updated by a user affirmatively selecting web content, such as an article, having an associated URL. Next, at 406, the web page corresponding to the selected web content is parsed for links For example, the links can point to other web content such as advertisements, images, banners, and other related pages. In some embodiments the amount of web content to be archived can be user defined. At 408, the URL of the selected web content is associated with a location in a local memory. At 410, the selected web content including all links is stored at the memory location associated with the URL. Next, at 412 if based upon the parsing more web pages are identified, then control is passed to 414 for mapping navigation links to memory locations, otherwise process 400 ends.

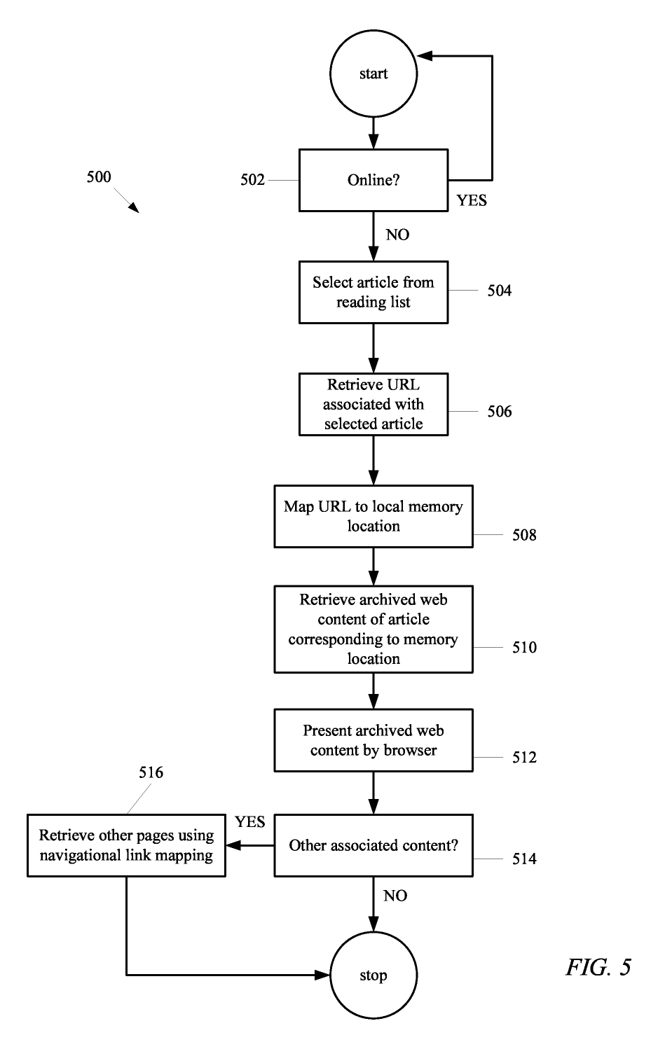

FIG. 5 shows a flowchart detailing an offline browsing process 500 in accordance with the described embodiments. Process 500 can begin at 502 by a determination if the browser has access to a network (i.e., is online). When the browser is determined to be offline, then at 504, web content is selected from a reading list. At 506, a URL associated with the selected web content is retrieved and at 508, a look up table modified during the archival process links that associated URL to a memory location in a local memory where archived web content associated with the selected web page is stored. At 510, the archived web content stored in the local memory at the memory location is retrieved and passed back to the browser for processing. At 512, if another web page or additional content is associated with the archived web content, then control is passed back to 516 where the other pages and/or content are retrieved using the navigation link mapping, otherwise process 500 ends.

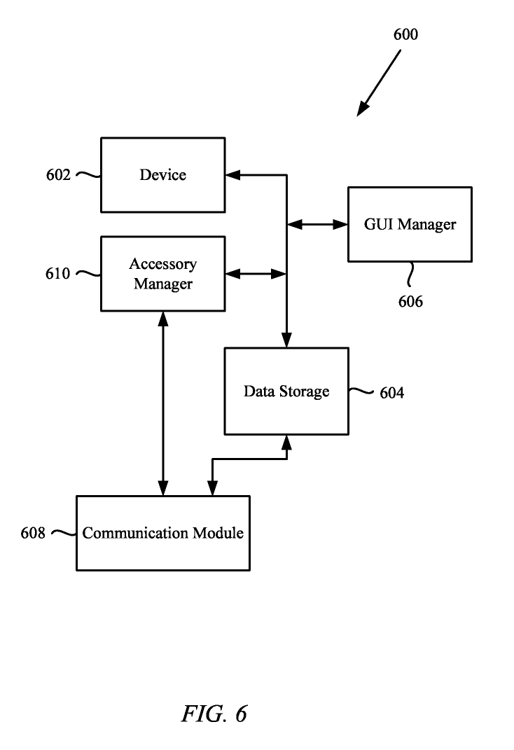

FIG. 6 is a block diagram of an arrangement 600 of functional modules utilized by an electronic device. The arrangement 600 includes an electronic device 602 that is able to output media for a user of the portable media device but also store and retrieve data with respect to data storage 604. The arrangement 600 also includes a graphical user interface (GUI) manager 606. The GUI manager 606 operates to control information being provided to and displayed on a display device. The arrangement 600 also includes a communication module 608 that facilitates communication between the portable media device and an accessory device. Still further, the arrangement 600 includes an accessory manager 610 that operates to authenticate and acquire data from an accessory device that can be coupled to the portable media device.

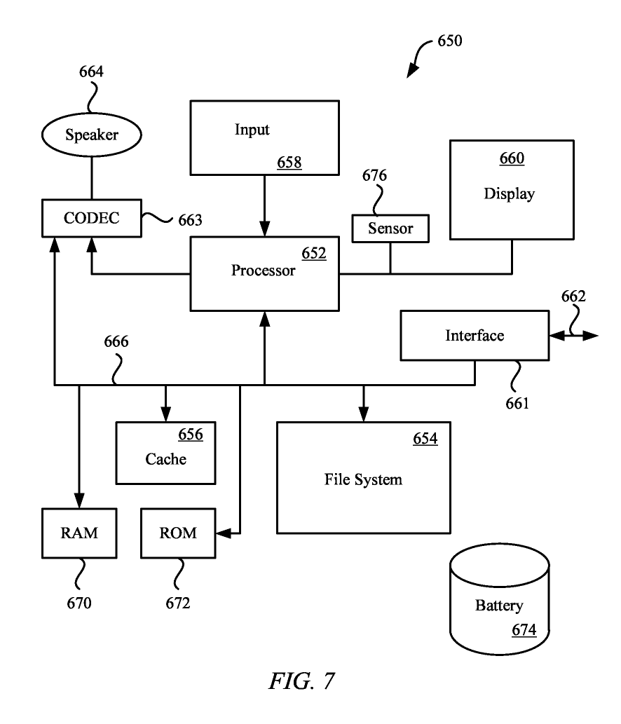

FIG. 7 is a block diagram of an electronic device 650 suitable for use with the described embodiments. The electronic device 650 illustrates circuitry of a representative computing device. The electronic device 650 includes a processor 652 that pertains to a microprocessor or controller for controlling the overall operation of the electronic device 650. The electronic device 650 stores media data pertaining to media items in a file system 654 and a cache 656. The file system 654 is, typically, a storage disk or a plurality of disks. The file system 654 typically provides high capacity storage capability for the electronic device 650. However, since the access time to the file system 654 is relatively slow, the electronic device 650 can also include a cache 656. The cache 656 is, for example, Random-Access Memory (RAM) provided by semiconductor memory. The relative access time to the cache 656 is substantially shorter than for the file system 654. However, the cache 656 does not have the large storage capacity of the file system 654. Further, the file system 654, when active, consumes more power than does the cache 656. The power consumption is often a concern when the electronic device 650 is a portable media device that is powered by a battery 674. The electronic device 650 can also include a RAM 670 and a Read-Only Memory (ROM) 672. The ROM 672 can store programs, utilities or processes to be executed in a non-volatile manner. The RAM 670 provides volatile data storage, such as for the cache 656.

The electronic device 650 also includes a user input device 658 that allows a user of the electronic device 650 to interact with the electronic device 650. For example, the user input device 658 can take a variety of forms, such as a button, keypad, dial, touch screen, audio input interface, visual/image capture input interface, input in the form of sensor data, etc. Still further, the electronic device 650 includes a display 660 (screen display) that can be controlled by the processor 652 to display information to the user. A data bus 666 can facilitate data transfer between at least the file system 654, the cache 656, the processor 652, and the CODEC 663.

In one embodiment, the electronic device 650 serves to store a plurality of media items (e.g., songs, podcasts, etc.) in the file system 654. When a user desires to have the electronic device play a particular media item, a list of available media items is displayed on the display 660. Then, using the user input device 658, a user can select one of the available media items. The processor 652, upon receiving a selection of a particular media item, supplies the media data (e.g., audio file) for the particular media item to a coder/decoder (CODEC) 663. The CODEC 663 then produces analog output signals for a speaker 664. The speaker 664 can be a speaker internal to the electronic device 650 or external to the electronic device 650. For example, headphones or earphones that connect to the electronic device 650 would be considered an external speaker.

The electronic device 650 also includes a network/bus interface 661 that couples to a data link 662. The data link 662 allows the electronic device 650 to couple to a host computer or to accessory devices. The data link 662 can be provided over a wired connection or a wireless connection. In the case of a wireless connection, the network/bus interface 661 can include a wireless transceiver. The media items (media assets) can pertain to one or more different types of media content. In one embodiment, the media items are audio tracks (e.g., songs, audio books, and podcasts). In another embodiment, the media items are images (e.g., photos). However, in other embodiments, the media items can be any combination of audio, graphical or visual content. Sensor 676 can take the form of circuitry for detecting any number of stimuli. For example, sensor 676 can include a Hall Effect sensor responsive to external magnetic field, an audio sensor, a light sensor such as a photometer, and so on.

The described embodiments can take many forms. For example, the attachment can occur between a first and second object where the first object and second object can take the form of electronic devices. The electronic devices can be magnetically attached to each other to form a cooperative electronic system in which the electronic devices can communicate with each other. As part of this communication, information can be passed between the first and second electronic devices. The information can be processed in whole or in part at either the first or second electronic device depending upon the nature of the processing. In this way, the cooperative electronic system can take advantage of the synergistic effect of having multiple electronic devices magnetically attached and in communication with each other. In one implementation, the communication can be carried out wirelessly using any suitable wireless communication protocol such as Bluetooth (BT), GSM, CDMA, WiFi, and so on.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The computer readable medium is defined as any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The advantages of the embodiments described are numerous. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

What is claimed is:

1. A computer implemented method for presenting essentially all content of an online article that spans more than one web page in a browser in an offline mode, the method comprising:
providing by the browser a URL associated with at least a first page of an article selected from a list of archived web articles;
using the URL to identify a memory location of stored web content data in a local memory device, the stored web content data corresponding to the selected at least first page of the article;
identifying navigation links associated with subsequent pages of the article, the navigation links being mapped to memory locations in the local memory associated with the subsequent pages;
retrieving the stored web content of the at least first page from the local memory location; and
presenting the web content of the at least first page by the browser.

2. The method as recited in claim 1, wherein the presented web content includes navigation links used to retrieve the stored web content of the subsequent pages of the article for presentation by the browser.

3. The method as recited in claim 2, wherein the web content data associated with the article is stored in the local memory prior to the selection only while the browser is on-line and in communication with a network arranged to provide the web content.

4. The method as recited in claim 2, wherein the first page web content data is stored to the local memory and navigation links associated with the subsequent pages are mapped to the memory concurrently with the user reading the article online and in communication with a network, and wherein when the network becomes unavailable while the user is reading the article, then web content data for the first page of the article and all subsequent pages of the article are automatically retrieved from the local memory as needed thereby preserving the online reading experience of the user while the network is unavailable.

5. A computer implemented method for presenting essentially all content of an online article by a browser in an offline mode, the archived version of the article comprising substantially all available online information associated with the article that spans more than one web page, the method comprising:
receiving a selection request of a page of the article, the selected page comprising a navigation link pointing to another page of the article;
providing by the browser a first URL associated with the selected page chosen from a list of web articles archived while the browser was in an online mode;
using the first URL to identify a first memory location of stored web content data in a local memory device, the stored web content data corresponding to the archived version of the selected page of the article;
retrieving the stored web content data of the selected page from the first memory location; and
presenting the retrieved web content data by the browser.

6. The method as recited in claim 5, wherein the navigation link is remapped during a preceding archival process of the article from a second URL associated with a world wide web location of the other page of the article to a second memory location in the local memory device associated with the archived version of the other page of the article.

7. The method as recited in claim 6, wherein when the browser is in an online mode receipt of the selection request for the selected page comprises directing the browser directly to the first URL.

8. The method as recited in claim 6, wherein the selected page web content data is stored to the local memory device and navigation links associated with other pages of the article are mapped to the memory concurrently with the user reading the article online and in communication with a network.

9. The method as recited in claim 8, wherein when the browser enters an offline mode while the user is reading the article, then web content data for the selected page of the article and all other pages of the article are automatically retrieved from the local memory device as needed thereby preserving the online reading experience of the user while the network is unavailable.

10. The method as recited in claim 6, wherein when a network providing online access to the browser is a slower communication protocol such as a 3G protocol a request to archive the selected page results only in the archiving of the selected page even when other pages are present and identifiable.

11. The method as recited in claim 6, wherein an amount of the online information associated with the archived version of the article can be user adjustable.

12. The method as recited in claim 11, wherein the amount of the online information associated with the archived version of the article at a maximum setting includes video and audio content associated with the article.

13. The method as recited in claim 5, wherein using the first URL to identify a first memory location of stored web content data comprises accessing a lookup table that maps original URL locations of archived articles to locations of those archived articles in the local memory device to determine the location of the stored web content data.

14. A non-transitory computer readable medium for storing computer instructions executed by a processor in a computing device having a web browser application, the method comprising:
computer code for receiving a request to store a selected page of an article located at a first URL while the web browser is in an online mode, the selected page comprising a navigation link pointing to another page with content from the article located at a second URL;
computer code for storing the first URL identified by the received request to a first memory location within a local memory device;
computer code for retrieving web content related to each page associated with the article; and
computer code for storing each page of the article to a second memory location in the local memory device.

15. The non-transitory computer readable medium as recited in claim 14, further comprising:
computer code for updating intra-article navigation links within each stored page of the article to correspond with locations of stored files within the second memory location; and
computer code for presenting a user-selectable link for accessing the selected page of the article,
wherein in an online state the user-selectable link directs the browser to the first URL recorded at the first memory location and in an offline state provides access to the archived article in a manner substantially indistinguishable from a normal web browsing experience.

16. The non-transitory computer readable medium as recited in claim 15, wherein the archived article is stored to the local device in a DOM tree format.

17. The non-transitory computer readable medium as recited in claim 15, wherein dynamic content associated with the archived article is captured during the storing process in a static format.

18. The non-transitory computer readable medium as recited in claim 17, wherein the captured dynamic content associated with the archived article can be periodically updated at selectable intervals during periods when the browser is in an online state.

19. The non-transitory computer readable medium as recited in claim 15, wherein when the browser is in an offline mode displaying the archived the article the browser still displays the URL originally associated with the online version of the article.

20. A computing system configured to archive essentially all of an article spread across more than one web page, the system comprising:
a local memory device; and
a browsing application, comprising:
an article selection control allowing a command from a user to be received that designate a web page for later off-line viewing,
a DOM tree generator configured to retrieve and parse web content data associated with a web page designated by the article selection control, wherein the parsing of the web content data allows the DOM tree generator to identify any other pages of the article that are available, wherein the DOM tree generator retrieves and parses web content of identified other pages, and wherein the parsed content of the selected page and other pages are saved to a location on the local memory device, and
a lookup table configured to correlate an original URL of the selected page and other pages with locations of associated parsed content on the local memory device.

21. The computing system as recited in claim 20, wherein the browsing application further comprises:
a list of archived articles allowing retrieval of the parsed data associated with the selected page of any given archived article,
wherein when an archived article is selected when the browser is in an offline mode the parsed content is assembled allowing a user to view the selected page in a manner that is substantially similar to an online browsing experience.

22. The computing system as recited in claim 21, wherein when an identified other web page is selected by a navigation link embedded within the archived version of the selected page, the archived version of the other page is displayed only when the browsing application is in an offline state at the time of the selection.

23. The computing system as recited in claim 21, wherein when the browsing application switches from an online state to an offline state while displaying a page that has been previously archived, subsequent selection of another page associated with the same article results in the browsing application displaying an archived version of the selected other page.

24. The computing system as recited in claim 21, wherein the other pages identified by the DOM tree generator include other pages not having portions of the article directly associated with the selected web page but are only identified as related articles that a user reading the article might also be interest in.
